(19) United States
(12) Patent Application Publication
(10) Pub. No.: US 2005/0027653 A1
(43) Pub. Date: Feb. 3, 2005

(54) System, method, and computer program product for network-based common operating environment with user-selectable services and billing

(75) Inventor: Mateen Jamil Greenway, Kingston-upon-Thames (GB)

Correspondence Address: DOCKET CLERK, DM/EDS, P.O. DRAWER 800889, DALLAS, TX, 75380, US

(73) Assignee: ELECTRONIC DATA SYSTEMS CORPORATION, Plano, TX (US)

(21) Appl. No.: 10/732,977

(22) Filed: Dec. 11, 2003

Related U.S. Application Data
(60) Provisional application No. 60/491,027, filed on Jul. 28, 2003.

(51) Int. Cl. G06F 17/60

(52) U.S. Cl. 705/40; 705/1

(57) ABSTRACT

A system, method, and computer program product for an improved data processing system common operating environment, in which a user can select specific applications, functions, and other content, which can each be individually authorized and billed.

### CROSS-REFERENCE TO RELATED APPLICATION

This application claims the benefit of the filing date of U.S. Provisional Patent Application 60/491,027 filed Jul. 28, 2003, entitled “System and Method for Network-Based Common Operating Environment,” which is hereby incorporated by reference.

### TECHNICAL FIELD OF THE INVENTION

The present invention is directed, in general, to data processing system operating environments.

### BACKGROUND OF THE INVENTION

The current common-operating-environment “COE” model is based upon the client desktop/laptop model of end-user access. The growth of the internet and the portal computing approaches to providing end-user access to corporate systems requires a new approach to the provision of services to end-users. In addition, feedback from some users of the current COE suggests that many of the users do not actually use much of the software that makes up COE, making it an expensive way of providing the few desktop applications they do use. Additionally the desktop/laptop is no longer the only client device in use. PDAs, mobile phones, tablet computers, and other internet enabled devices are already beginning to proliferate in the marketplace. If users have access to/from these devices at home it is not surprising that they would also expect to be able to use them at work.

In addition, the conventional COE model suffers in that it provides a common portal interface to most or all users, with common applications and services, even if many of those users don't require those applications or services. As a result, great power and expense is wasted by providing a generic portal interface to most or all users.

There is, therefore, a need in the art for a system, process and data format for an improved common operating environment.

### SUMMARY OF THE INVENTION

A preferred embodiment provides a system, method, and computer program product for an improved data processing system common operating environment, in which a user can select specific applications, functions, and other content, which can each be individually authorized and billed.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a block diagram of a data processing system network in which an embodiment of the present invention can be implemented;

FIG. 2 depicts a block diagram of a data processing system in which a preferred embodiment can be implemented;

FIG. 3 depicts a block diagram of the components of a system in accordance with the preferred embodiment; and

FIG. 4 depicts a flowchart of a process in accordance with a preferred embodiment.

### DETAILED DESCRIPTION OF THE INVENTION

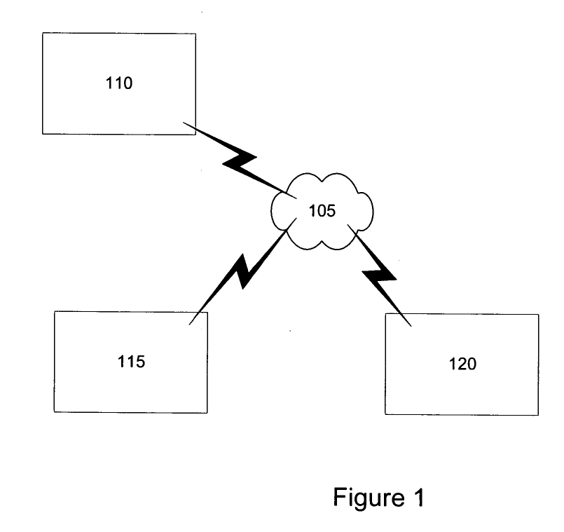

FIGS. 1 through 4 and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

A preferred embodiment provides a system, method, and computer program product for an improved data processing system common operating environment, referred to herein as “MyCOE,” in which a user can select specific applications, functions, and other content, which can each be individually authorized and billed.

FIG. 1 depicts a block diagram of a data processing system network in which an embodiment of the present invention can be implemented. In this figure, network 105 is any known type of computer network, including private networks or public networks such as the internet. While network 105 is shown in only one instance here; as known to those of skill in the art, network 105 can be implemented in multiple separate networks, or in the same public or private network system. Of course, any data or network communication described herein can be implemented using any known data communications means, such as via telephone modem, xDSL, fiber optic, wireless, etc., or public or private networks. These communications will include data pertaining to purchases and refunds, taxes, and other functions, as known in the art and/or as specifically described below.

Server 110 is shown communicating client systems 115/120 via network 155. Server system 110 is a data processing system server, configured to communicate with multiple different client systems, including client systems 115/120 and others.

It is understood that client systems 115/120 and server system 110 may be co-located or placed at different locations, or be otherwise structured as known to those of skill in the art, so long as they are capable of together performing the functions described and claimed herein.

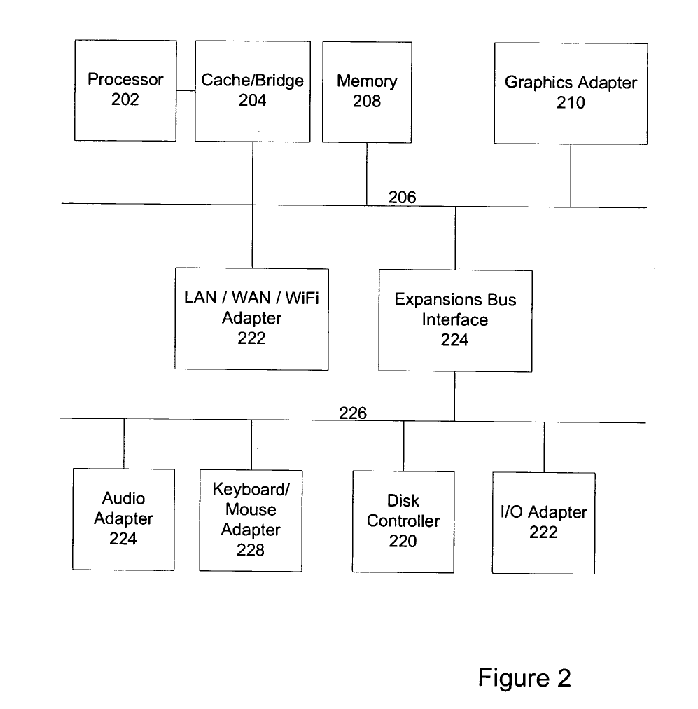

FIG. 2 depicts a block diagram of a data processing system in which a preferred embodiment can be implemented. The data processing system depicted includes a processor 102 connected to a level two cache/bridge 204, which is connected in turn to a local system bus 206. Local system bus 206 may be, for example, a peripheral component interconnect (PCI) architecture bus. Also connected to local system bus in the depicted example are a main memory 208 and a graphics adapter 210.

Other peripherals, such as local area network (LAN)/Wide Area Network/Wireless (e.g. WiFi) adapter 212, may also be connected to local system bus 206. Expansion bus interface 214 connects local system bus 206 to input/output (I/O) bus 216. I/O bus 216 is connected to keyboard/mouse adapter 218, disk controller 220, and I/O adapter 222.

Also connected to I/O bus 216 in the example shown is audio adapter 224, to which speakers (not shown) may be connected for playing sounds. Keyboard/mouse adapter 218 provides a connection for a pointing device (not shown), such as a mouse, trackball, trackpointer, etc.

Those of ordinary skill in the art will appreciate that the hardware depicted in FIG. 2 may vary for particular. For example, other peripheral devices, such as an optical disk drive and the like, also may be used in addition or in place of the hardware depicted. The depicted example is provided for the purpose of explanation only and is not meant to imply architectural limitations with respect to the present invention.

A data processing system in accordance with a preferred embodiment of the present invention includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present invention as described.

The myCOE client solution is, in the preferred embodiment, entirely browser-based and user definable. Applications delivered can be either deployed to PC desktop, or accessed via desktop or browser, and web services accessed via browser. In the preferred embodiment, the applications and services are delivered to the user within an enterprise common operating environment, where the enterprise is a company, school, government unit, or other similar enterprise.

Preferably, access to myCOE is role specific with additional options only available to specific classes of users. For example, access to myCOE usage can be made only available to managers. myCOE provides user selectable application deployment via an on line menu. Selectable applications include applications (e.g., Microsoft Office Software, Client Specific Applications, Lotus Notes, Microsoft Exchange mail, etc). The ala carte system provides a more flexible alternative to the traditional fixed PC load approach supporting multiple new desktop models, e.g., traditional desktop, thin-client, or browser-based as required. The disclosed system Allows companies to choose how they evolve their services, where some might move to completely thin-client, while others need lots of mobile access. Further, this can be provided to sections of the company via the role based approach.

In practice the menu selection structure is laid out so as to help users locate what they are looking for, providing “assisted selection” (e.g. “I want to work form home”) and showing prices and amount spent to date.

Supporting this is centralized automatic maintenance of user information (e.g. addition, update or removal of the selected/deselected service options as chosen by the user) and the automatic link/feed of this info into the billing process. It is important that this information be current, credible, auditable and reportable to be a basis for billing—i.e. somewhat better than the quality of data we normally have). The active directory is preferably the vehicle for maintaining this information, and alternatively there is a separate user database.

Selecting a particular application automatically initiates a workflow process that obtains authorization for the application use from the appropriate levels of customer management. Installation and access is provided through automated installs or access to web services as appropriate and to supports installation to client desktop, access via standard myCOE browser, and installation to and/or browser access via PDA and tablet computers.

The menu selection preferably provides an automated interface to the billing mechanism as to ensure that subscription/usage information is correctly recorded.

This also allows users who do not have access to a customer client PC to access corporate systems and information if authorised to do so. myCOE supports access by non-customer staff (e.g., temporary staff) via a web browser interface, and customer staff at non-customer locations, including internet cafes and via PDAs.

According to the preferrred embodiment, all services are accessible as Web Services via the browser interface. Applications are preferably either installed to client hardware, wrappered in J2EE or Microst .NET code to allow them to be accessed via a web browser, deployed via Microsoft Windows Terminal Service and/or Citrix Metaframe, or front-ended via HTML/Java/XML.

Users are also able to tailor the layout as well as the look and feel of their myCOE screens, as illustrated.

The content of the myCOE basebuild is reduced to the minimum to reduce customer costs, with greater flexibility in the selection of add-ons. For example, the base option can be SMTP mail accessed via a WebMail style interface.

Base options, such as mobile hand held devices, which offer greater mobility at a reduced cost, are included. Client options include connectivity to the web browser interface via commonly available devices.

Installation of a specific offering uses the automatic allocation of appropriate access to network (INF) resources, CPU and disk storage as appropriate. For example, adding a user to Microsoft's Outlook email system would require setup of userid on appropriate email server, allocation of space for user mailbox, network and security access to email system, and allocation of any additional CPU's to email server based on increase in user numbers.

The user also has the option of discontinuing access to specific applications based on system rules. For example, users selecting access to Microsoft Project might be required to agree to a minimum subscription period (e.g., one month, one quarter, one year, etc.)

User self-help tools designed around expert system concepts will provide assistance to users where required reducing the need to contact the helpdesk.

Billing for this service will be per user and per application. This form of microbilling provides activity based costing will allow myCOE customers to track and control their expenditure on this servivce at a detailed level.

The myCOE system also includes management reporting and administration of customer data such as user information (location, billing address, etc.), hierarchies (for reporting) and authorities (authorised requesters, approvers, etc.).

Implicit is the need for secure network access for users. This is especially true for remote (e.g., internet café) users, and will need to provided though strong encryption and VPN technology. In addition, the myCOE model is designed around the concept of single user sign-on. Preferably, user access is secure and non-repudiatable in the myCOE environment.

To enable a shared service, offerings are defined in terms of business functionality, not technology. The preferred embodiment provides a “light client” browser based environment where applications are accessed and executed as remote web services support for more device types for staff, customers and suppliers.

The myCOE approach allows authorized users to access corporate systems via any device, irrespective of type or ownership.

One advance made by myCOE is the bringing together of a number of current technologies, Portal, Deployment, Hosting, thin client, user self-help, helpdesk, collaboration, web services, Billing in order to provide Desktop and Business services to an end consumer on a utility basis. They only select and use the services they need, wherein a conventional COE approach forces everyone to have the same, as a one size fits all. Consequently, the user only pay, ultimately at the end user level, for the services they have subscribed to, typically on a mointhly basis. Most of the services delivered through the myCOE. Portal Framework will be existing services such as Helpdesk, SMC, Hosting, etc.

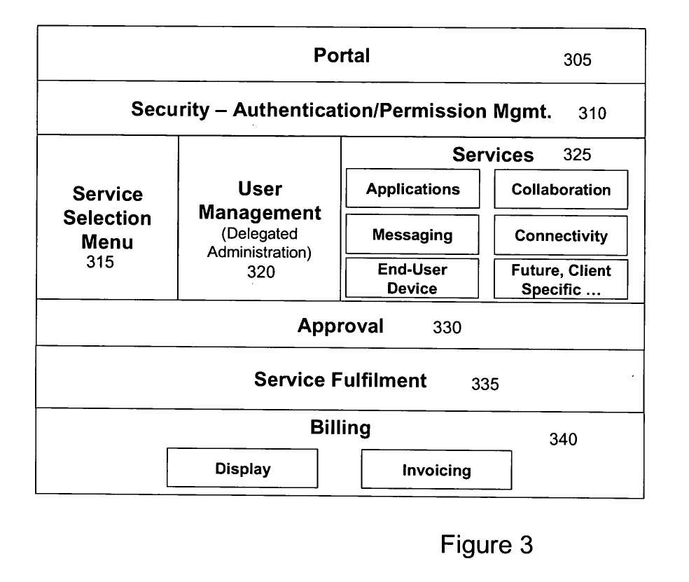

FIG. 3 depicts a block diagram of the components of a system in accordance with the preferred embodiment. Shown here is the portal 305 that is displayed to the user and the security component 310 used to validate the identity and permissions of the user.

Service selection menu 315 allows the user to select the services 325 to be available in the myCOE environment, including applications, collaboration, messaging, connectivity, end-user devices, and other current and future client-specific devices and services.

Approval component 330 is used to approve the user's service selections, and service fulfillment 335 is used to provision the requested services 325.

Finally, billing component 340 is used to provide pricing information for available services and to track, invoice, and display billing for the services selected by the user.

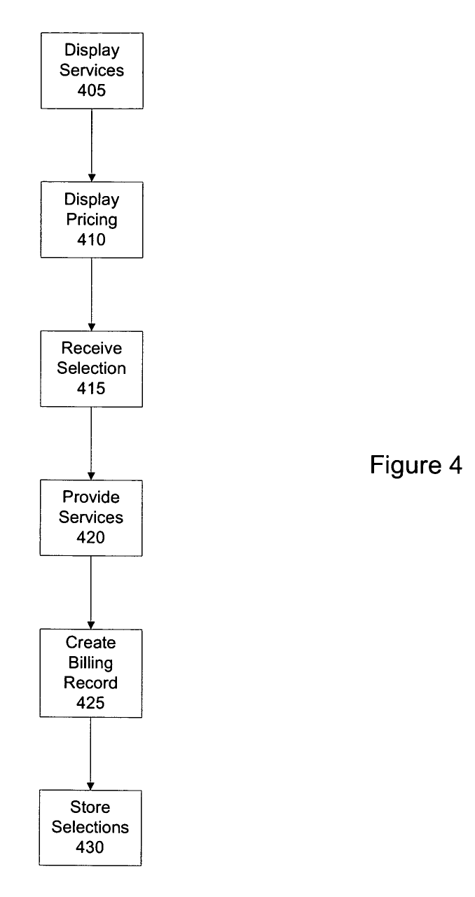

FIG. 4 depicts a flowchart of a process in accordance with a preferred embodiment. Here, the system displays to the user a list of available services (step 405). The services can include applications, collaboration, messaging, connectivity, end-user devices, and other current and future client-specific devices and services.

The system also displays to the user pricing information corresponding to the available services (step 410). The system receives a user selection of services (step 415).

The system makes the selected services available to the user (step 420), by using any known provisioning method, and creates a billing record corresponding to the user and selected services (step 425).

The system also stores the user's selected services (step 430), so they are available to the user the next time he uses the system.

Those skilled in the art will recognize that, for simplicity and clarity, the full structure and operation of all data processing systems suitable for use with the present invention is not being depicted or described herein. Instead, only so much of a system as is unique to the present invention or necessary for an understanding of the present invention is depicted and described. The remainder of the construction and operation of data processing system may conform to any of the various current implementations and practices known in the art.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

1. A method for providing data processing services, comprising:
sending a list of available services to be displayed to a user, the list of available services including pricing information for at least some available services;
receiving a user selection of a service;
providing the selected service to the user;
creating a billing record indicating the selected service and the user; and
storing the user selection, wherein the services are provided within an enterprise common operating environment.

2. The method of claim 1, wherein the services include local applications.

3. The method of claim 1, wherein the services include server-based applications.

4. The method of claim 1, wherein each service can be individually selected and billed to the user.

5. The method of claim 1, wherein the services are billed to the user's business unit.

6. The method of claim 1, wherein the user can thereby select only required services to use within a common operating environment.

7. The method of claim 1, wherein the list of available services is customized to the user's role within the enterprise.

8. A data processing system having at least a processor and accessible memory, comprising:
means for sending a list of available services to be displayed to a user, the list of available services including pricing information for at least some available services;
means for receiving a user selection of a service;
means for providing the selected service to the user;
means for creating a billing record indicating the selected service and the user; and
means for storing the user selection, wherein the services are provided within an enterprise common operating environment.

9. The data processing system of claim 8, wherein the services include local applications.

10. The data processing system of claim 8, wherein the services include server-based applications.

11. The data processing system of claim 8, wherein each service can be individually selected and billed to the user.

12. The data processing system of claim 8, wherein the services are billed to the user's business unit.

13. The data processing system of claim 8, wherein the user can thereby select only required services to use within a common operating environment.

14. The data processing system of claim 8, wherein the list of available services is customized to the user's role within the enterprise.

15. A computer program product tangibly embodied in a machine-readable medium, comprising:
instructions for sending a list of available services to be displayed to a user, the list of available services including pricing information for at least some available services;
instructions for receiving a user selection of a service;
instructions for providing the selected service to the user;
instructions for creating a billing record indicating the selected service and the user; and
instructions for storing the user selection, wherein the services are provided within an enterprise common operating environment.

16. The computer program product of claim 15, wherein the services include local applications.

17. The computer program product of claim 15, wherein the services include server-based applications.

18. The computer program product of claim 15, wherein each service can be individually selected and billed to the user.

19. The computer program product of claim 15, wherein the services are billed to the user's business unit.

20. The computer program product of claim 15, wherein the user can thereby select only required services to use within a common operating environment.

21. The computer program product of claim 15, wherein the list of available services is customized to the user's role within the enterprise.
